(19) United States
(12) Patent Application Publication
(10) Pub. No.: US 2018/0270205 A1
(43) Pub. Date: Sep. 20, 2018

(54) FINGERPRINT-SENSING INTEGRATED CIRCUIT AND SCRAMBLING ENCRYPTION METHOD THEREOF

(71) Applicant: Image Match Design Inc., Zhubei City (TW)

(72) Inventor: Sun-How JIANG, Hsinchu City (TW)

(21) Appl. No.: 15/459,910

(22) Filed: Mar. 15, 2017

(51) Int. Cl. H04L 29/06; H04L 9/08; H04L 9/14

(52) U.S. Cl. CPC H04L 63/0428; H04L 9/14; H04L 9/0861; H04L 63/0861

(57) ABSTRACT

A fingerprint-sensing integrated circuit encrypts fingerprint image data before transmitting the fingerprint image data to a remote system host through a Tx/Rx interface so as to prevent the fingerprint image data from being skimmed, or to prevent verification of a stolen fingerprint image data sent to the system host. The scrambling encryption method does not need an SRAM, a DRAM or a flash memory for design of the encryption circuit, and the data volume remains unchanged after encryption, thereby preventing latency and delay during data encryption/decryption and data transmission.

### FIELD OF THE INVENTION

The present invention relates to a fingerprint-sensing integrated circuit (IC), and more particularly to a fingerprint-sensing IC capable of applying scrambling encryption to a fingerprint and its scrambling encryption method.

### BACKGROUND OF THE INVENTION

A conventional fingerprint-sensing system integrates the fingerprint-sensing function and the identification function in one IC. However, having these functions in a single IC makes production of system circuits less flexible, and has adverse impact on the yield of chips. In addition, many applications require the fingerprint-sensing function and the identification function to be separately provided at a user end and at a system host that are connected by means of a Tx/Rx (transmitter/receiver) interface. As shown in FIG. 1, after a conventional fingerprint sensor 13 obtains a fingerprint image by sensing a finger, a Tx/Rx interface 191 transmits the fingerprint image data to a system host 15, for example a micro-controller unit (MCU), that verifies the user's identification. Nevertheless, in the process where the Tx/Rx interface 191 transmits the fingerprint image data, there is a risk that someone may be skimming the fingerprint image data, for example using a skimming interface 193 identical to the Tx/Rx interface 191 in terms of specification, to record the fingerprint image data in an illegal device 17, for example a micro-controller unit (MCU 1). As shown in FIG. 2, the stolen fingerprint image data may be stored in a storage device 18. When an illegal user uses the storage device 18 instead of the fingerprint sensor 13 to send out the fingerprint image data through a Tx/Rx interface 195 pretending the Tx/Rx interface 191 to the system host 15, the illegal user has its identification verified. Thus, encryption of fingerprint image data is necessary for safe transmission of fingerprint data. However, as the fingerprint sensor has a limited chip area, it is difficult to incorporate an SRAM, a DRAM or a flash memory on an IC for design of an encryption circuit.

### SUMMARY OF THE INVENTION

An objective of the present invention is to provide a fingerprint-sensing IC and a scrambling encryption method that enable scrambling encryption of fingerprint data.

According to the present invention, a fingerprint-sensing IC comprises a fingerprint-sensing device for sensing a fingerprint to generate fingerprint image data, a linear feedback shift register (LFSR) for generating a plurality of scrambling values according to a key, and a scrambling encryption circuit for performing scrambling encryption on the fingerprint image data using the plurality of scrambling values so as to generate secured fingerprint image data. The fingerprint image data and its secured version are equivalent in terms of data volume, thereby preventing latency or delay during data transmission.

According to the present invention, a scrambling encryption method for a fingerprint-sensing IC comprises sensing a fingerprint to generate fingerprint image data, generating a plurality of scrambling values based on a key, and performing scrambling encryption on the fingerprint image data using the plurality of scrambling values so as to generate secured fingerprint image data that is sent to a system host through a Tx/Rx interface for fingerprint verification. The fingerprint image data and its secured version are equivalent in terms of data volume, so latency or delay is prevent during data transmission.

According to the present invention, a fingerprint-sensing IC comprises a fingerprint-sensing device, a linear feedback shift register and a scrambling encryption circuit. The fingerprint-sensing device senses a fingerprint to generate fingerprint image data that is divided into a plurality of sectors, each of which contains a plurality of first pixel data. The linear feedback shift register generates a plurality of scrambling values according to the key corresponding to the sector to be encrypted presently. The scrambling encryption circuit uses the plurality of scrambling values to perform scrambling encryption on the plurality of first pixel data of the sector to be encrypted presently, so as to generate a plurality of second pixel data. After all the sectors are processed by scrambling encryption, all the generated second pixel data form secured fingerprint image data. The fingerprint-sensing IC transmits the secured fingerprint image data to a remote system host through a Tx/Rx interface for fingerprint verification. The fingerprint image data and its secured version are equivalent in terms of data volume, so latency or delay is prevent during data transmission.

According to the present invention, a scrambling encryption method for a fingerprint-sensing IC comprises sensing a fingerprint to generate fingerprint image data, dividing the fingerprint image data into a plurality of sectors, each of which contains a plurality of first pixel data, providing a key according to the sector to be encrypted presently, generating a plurality of scrambling values based on the key, and using the plurality of scrambling values to perform scrambling encryption on the plurality of first pixel data of the sector to be encrypted presently, so as to generate a plurality of secured second pixel data. After all the sectors are processed by scrambling encryption, all the generated second pixel data form secured fingerprint image data. The fingerprint-sensing IC transmits the secured fingerprint image data to a remote system host through a Tx/Rx interface for fingerprint verification. The fingerprint image data and its secured version are equivalent in terms of data volume, so latency or delay is prevent during data transmission.

The present invention encrypts a fingerprint without using an SRAM, a DRAM or a flash memory, so as to keep the integrated fingerprint-sensing IC minimized.

### BRIEF DESCRIPTION OF THE DRAWINGS

These and other aspects of the present invention will be described in more details, with reference to the appended drawings showing example embodiments of the present invention, wherein:

FIG. 1 shows a conventional fingerprint verification system;

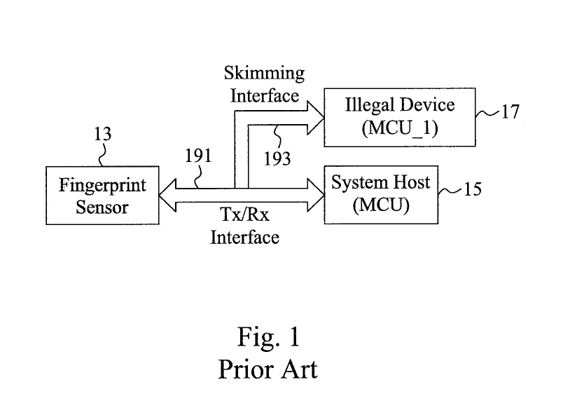

FIG. 2 illustrates verification when using stolen fingerprint image data;

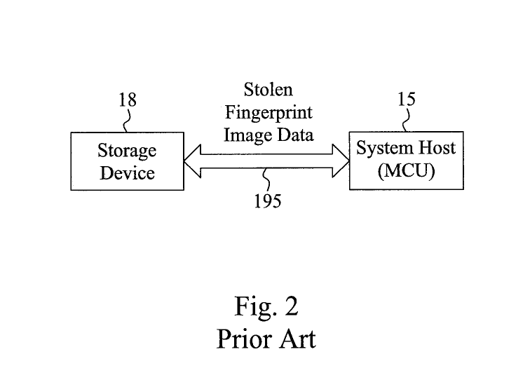

FIG. 3 shows an embodiment of a fingerprint-sensing IC according to the present invention;

FIG. 4 is an embodiment of the linear feedback shift register shown in FIG. 3;

FIG. 5 is an embodiment of the scrambling encryption circuit shown in FIG. 3;

FIG. 6 shows a first embodiment of the key generator shown in FIG. 3;

FIG. 7 shows a second embodiment of the key generator shown in FIG. 3;

FIG. 8 shows a third embodiment of the key generator shown in FIG. 3;

FIG. 9 shows a fourth embodiment of the key generator shown in FIG. 3;

FIG. 10 shows a first embodiment of division of sectors of fingerprint image data;

FIG. 11 shows a second embodiment of division of sectors of fingerprint image data; and

FIG. 12 shows a third embodiment of division of sectors of fingerprint image data.

### DETAILED DESCRIPTION OF THE INVENTION

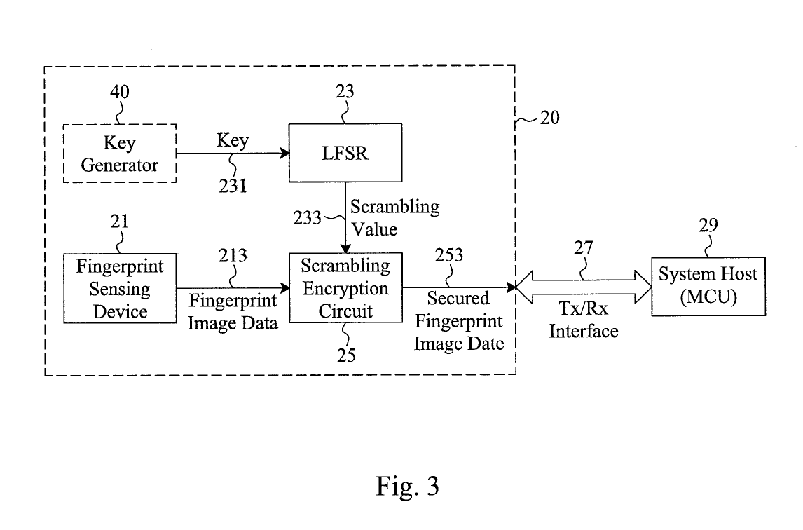

Referring to FIG. 3, a fingerprint-sensing IC 20 according to the present invention comprises a fingerprint-sensing device 21, a linear feedback shift register 23, and a scrambling encryption circuit 25. When a user touches the fingerprint-sensing IC 20 with a finger, the fingerprint-sensing device 21 senses the finger's fingerprint and generates fingerprint image data 213, the linear feedback shift register 23 generates a plurality of scrambling values 233 according to a key 231, and the scrambling encryption circuit 25 uses the plurality of scrambling values 233 provided by the linear feedback shift register 23 to perform scrambling encryption on the fingerprint image data 213 provided by the fingerprint-sensing device 21, so as to generate secured fingerprint image data 253. The fingerprint-sensing IC 20 then transmits the secured fingerprint image data 253 to a system host 29 through a Tx/Rx interface 27 for fingerprint verification. In this case, even if someone is skimming the secured fingerprint image data 253 during transmission of the secured fingerprint image data 253, it is impossible to retrieve the original fingerprint at any device without the decryption keyword, namely the key 231 or the scrambling value 233. On the other hand, even if the user's fingerprint is otherwise collected, it is impossible to encrypt the fingerprint and send it to the system host 29 through a Tx/Rx interface for decryption without the key 231 and the scrambling value 233. Security of fingerprint transmission is thus improved.

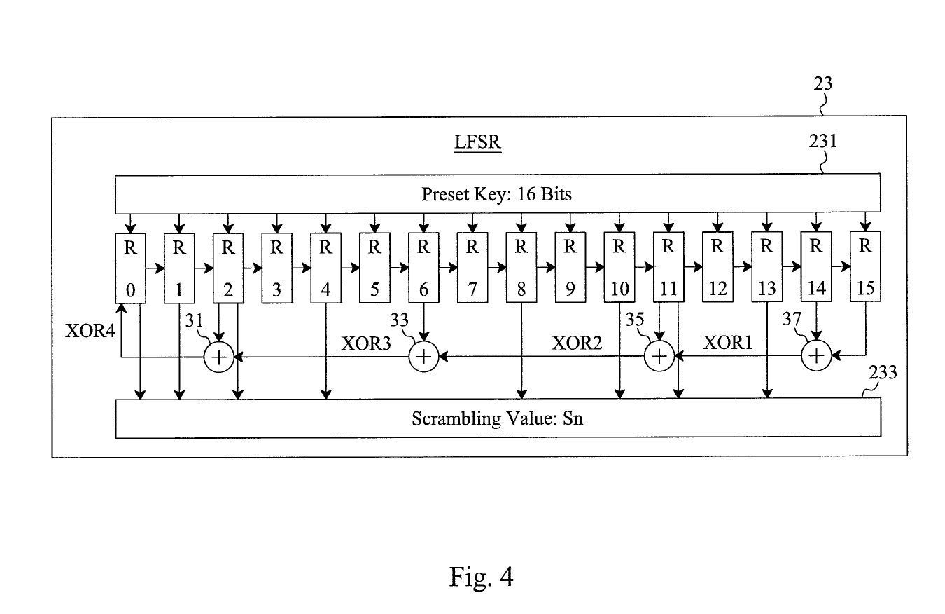

FIG. 4 is an embodiment of the linear feedback shift register 23 shown in FIG. 3, which comprises a plurality of registers R0-R15 and a plurality of XOR gates 31, 33, 35 and 37. The linear feedback shift register 23 shown in FIG. 3 may be represented using a linear polynomial P(x)=x¹⁶+x¹⁵+x¹²±x⁷±x³+1. After loaded into the linear feedback shift register 23, the key 231 has its every bit stored in a corresponding one of the registers R0-R15. In this embodiment, the key 231 has 16 bits, while in other embodiments, the form of the linear feedback shift register 23 and in turn the number of the bits of the key 231 may be changed by setting the linear polynomial P(x) according to practical needs. The linear feedback shift register 23 may shift the bit values stored in the shift register R0-R15 according to a clock signal. For example, every time the clock signal triggers a pulse, the bit values are shifted once. The clock signal may be provided by a circuit built in or external to the linear feedback shift register 23. In this embodiment, when the linear feedback shift register 23 shifts the bit values, the XOR gate 37 generates a bit value XOR1 according to the bit values of the registers R14 and R15 at that time, and the XOR gate 35 generates a bit value XOR2 according to the bit value of the register R11 at that time and the bit value XOR1, the XOR gate 33 generates a bit value XOR3 according to the bit value of the register R6 at that time and the bit value XOR2, the XOR gate 31 generates a bit value XOR4 according to the bit value of the register R2 at that time and the bit value XOR3 for the register R0, the bit value originally in the register R0 is shifted to the next register R1, and the bit value originally in the register R1 is shifted to the next register R2, and so on. The bit values originally in the registers R2-R14 are all shifted to the next registers R3-R15. In FIG. 3, the number of the XOR gates and whether each of the XOR gates is connected to a register or an XOR gate at its input end, namely the form of the linear feedback shift register 23, may be changed according to practical needs. Moreover, in some other embodiments, a logic operation circuit is used instead of the XOR gate. Due to the periodic nature of the linear feedback shift register, for preventing from repeat of scrambling values that may be used to do inverse computation and decryption, the number of shifts is preferably limited.

The linear feedback shift register 23 shown in FIG. 4 with the key 231 loaded provides a first scrambling value S0={R0, R1, R2, R4, R8, R10, R11, R13} that contains the bit value of the register R0 before performing any shift or after performing at least one shift. Then, after at least one more shift, the linear feedback shift register 23 provides a second scrambling value S1={R0, R1, R2, R4, R8, R10, R11, R13}. In this manner, a scrambling value Sn is generated after every at least one shift. In the embodiment of FIG. 4, the scrambling value Sn having 8 bits is obtained by selecting the registers R0, R1, R2, R4, R8, R10, R11, R13. In other embodiments, the registers other than the register R0 that is necessary may be selected freely to determine the scrambling value. Also, the number of bits of the scrambling value Sn may be increased or decreased.

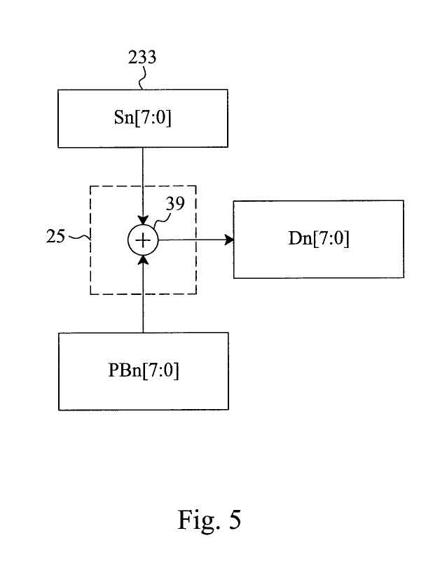

FIG. 5 shows an embodiment of the scrambling encryption circuit 25 shown in FIG. 3, which comprises an XOR gate 39. The fingerprint image data 213 contains a plurality of first pixel data PBn, and the XOR gate 39 generates second pixel data Dn=PBn⊕Sn of the secured fingerprint image data by performing XOR operation with each first pixel data PBn and a scrambling value Sn, where n is an integer. According to the linear equation P(x)=x¹⁶+x¹⁵+x¹²+x⁷+x³+1 of the linear feedback shift register 23 shown in FIG. 4, n is an integer ranging between 0 and 4095. As shown in FIG. 4 and FIG. 5, the disclosed encryption method requires only the registers R0-R15 and the logic operation circuit, without using an SRAM, a DRAM or a flash memory. Besides, the first pixel data PBn before encryption and the second pixel data Dn after encryption have the same number of bits, i.e. eight, so the data volume remains unchanged after encryption. This reduces the risk of latency and delay during data transmission for encryption and decryption of the fingerprint image data, thereby ensuring smooth transmission of the fingerprint image data.

The key 231 shown in FIG. 3 may be generated directly by the system host 29 and delivered to the fingerprint-sensing IC 20 through the Tx/Rx interface 27. Alternatively, it may be generated directly by the fingerprint-sensing IC 20, or may be generated as an agreement between the system host 29 and the fingerprint-sensing IC 20. The key 231 may be constant or variable. For a constant key 231, it has to be embedded in the hardware of the fingerprint-sensing IC 20 and the system host 29 for preventing software-based decryption. For a variable key 231, it may be set to randomly change or change under conditions.

While the key 231 may be directly generated as described previously, it may be generated indirectly. Indirect generation of the key 231 requires one or a plurality of predefined seeds. The seeds are of fixed values and embedded in the hardware of the system host and the fingerprint-sensing IC for preventing software-based decryption. The system host 29 and the fingerprint-sensing IC 20 both require another linear feedback shift register as the key generator 40 so as to generate the key 231, as shown in FIG. 3. In this case, what is transmitted through the Tx/Rx interface 27 is not the key 231, but a standard bit sequence. Thus, any illegal user can only get the bit sequence from the Tx/Rx interface, and has no way to get the correct key 231. The bit sequence may be defined by the system host 29 and then sent to the fingerprint-sensing IC 20, or be defined by the fingerprint-sensing IC 20 and then sent to system host 29, or be agreed between and sent to the two parties. In one embodiment, the bit sequence is agreed by the process as follows. The fingerprint-sensing IC 20 sends a set of information to the system host 29, for example 00000001, and the system host 29 sends another set of information to the fingerprint-sensing IC 20, for example 10000000. The system host 29 and the fingerprint-sensing IC 20 each combines or operates the two sets of information to get a bit sequence, for example 10000001. After the system host 29 and the fingerprint-sensing circuit 20 get the bit sequence simultaneously, the key generator of the system host 29 and the key generator 40 of the fingerprint-sensing IC 20 each selects the seed according to this bit sequence and performs shift so as to generate the key 231. The keys generated by the system host 29 and by the fingerprint-sensing IC 20 have to be the same. The key generator 40 of the system host 29 may be realized using hardware so as to prevent the seed to be found out by anyone coming to know the format of the standard bit sequence.

The information of the bit sequence includes the number of times of shifts and the selected seed. Taking a bit sequence of 16 bits for example, the first two bits are for selecting the seed, and the latter 14 bits represent how many times the key generator 40 performs shift. In this example, assuming there are 4 seeds, 16′h5500, 16′h5400, 16′h0020, and 16′h0080, and the bit sequence is 16′hC800, where 16′ refers to that there are 16 bits, and h indicates that the data following it are hexadecimal. Thus, the bit sequence 16′hC800 when expressed in the binary system is 1100100000000000, wherein the first two bits, 11, mean the fourth seed 16′h0080 is used, and the latter 14 bits represent 2048 shifts. The key generator of the system host 29 and the key generator 40 of the fingerprint-sensing IC 20 when working in this manner with each other can get an identical key.

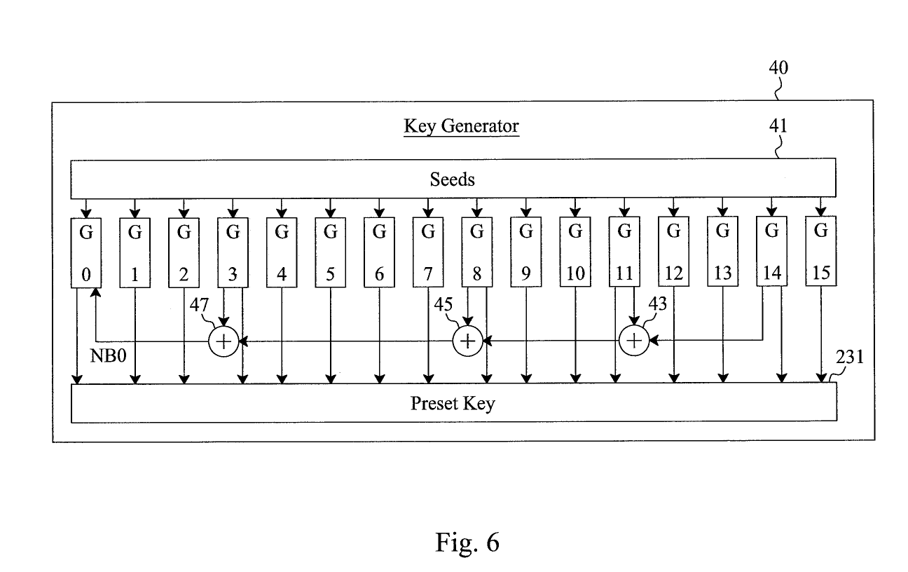

FIG. 6 shows a first embodiment of the key generator 40, which comprises a plurality of registers G0-G15 and a plurality of XOR gates 43, 45 and 47. After the seed 41 selected from the plurality of predetermined seeds according to the bit sequence is loaded to the key generator 40, the seed 41 has its bit values stored in the registers G0-G15, respectively. Afterward, shifts are performed for the times set according to the bit sequence and the key 231 is generated. The key generator 40 of FIG. 6 performs shifts in the way same as the linear feedback shift register 23 of the FIG. 4. The bits of the registers G0-G14 are shifted to the following registers G1-G15. The XOR gates 43, 45 and 47, according to the current bit values of the registers G3, G8, G11 and G14, generate a new bit value NB0 for the register G0. In some other embodiments, the number of the registers G0-G15 is variable, and the number and locations of the XOR gates 43, 45 and 47 are also changed. Moreover, the XOR gates 43, 45 and 47 may be replaced by other logic operation circuits.

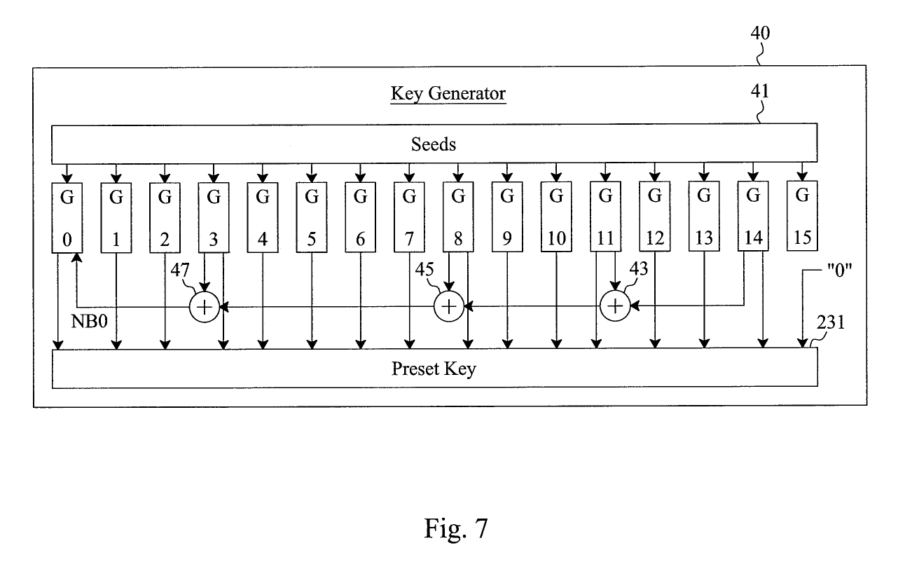

In addition, some bits of the key 231 may be set as predetermined, fixed values that are independent of the shifts of the linear feedback shift register 40 so as to prevent software-based decryption. FIG. 7 shows a second embodiment of the key generator 40. The circuit of FIG. 7 is similar to that shown in FIG. 6, with the difference that the bit of the register G15 is not output to be the last bit of the key 231, which is instead of a predetermined, fixed value, “0”. In the embodiment of FIG. 7, only one bit of the key 231 is set as a predetermined, fixed value. In other embodiments, more than one bit in the key 231 may be set as predetermined, fixed values.

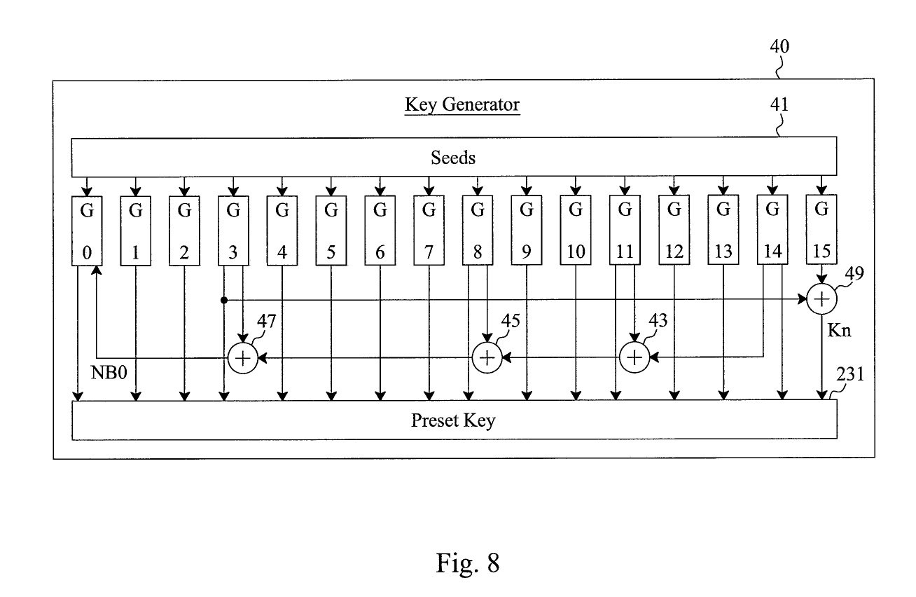

In addition to setting one or a plurality of bits of the key 231 as predetermined, fixed values, also possible is to generate a specific bit by operating the bit values in some of the registers G0-G15 and using it as one of the bits of the key. FIG. 8 shows a third embodiment of the key generator 40. The circuit of FIG. 8 is similar to that shown in FIG. 6, with the difference that instead using the bit of the register G15 as the last bit of the key 231, the key generator 40 uses a specific bit as a result that the XOR gate 49 performs an XOR operation on the bit values of the registers G3 and G15 as the last bit of the key 231. Designation of the specific bit Kn is programmable. For example, this time the bits of the registers G3 and G15 are used to generate the specific bit Kn, and next time the key is to be generated, the bits of registers G2 and G8 are designated for generating the specific bit Kn. In other embodiments, the XOR gate 49 may be replaced by other logic operation circuits.

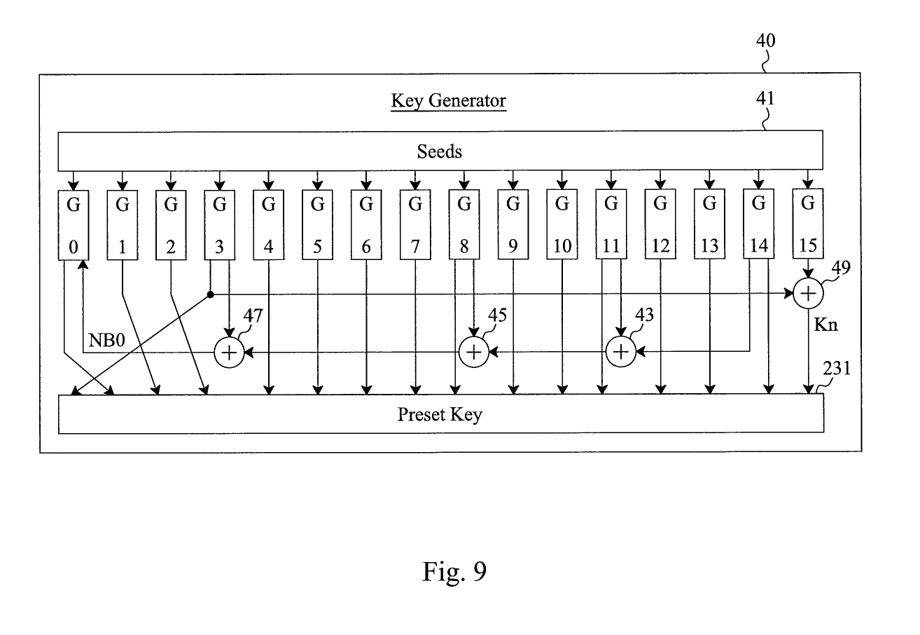

FIG. 9 shows a fourth embodiment of the key generator 40. The circuit of FIG. 9 is similar to that shown in FIG. 8, with the difference that the corresponding locations of the bits of the registers G0-G3 in the key 231 are changed. Particularly, the bits of the registers G0-G2 are used as the second, third and fourth bits of the key 231, respectively, and the bit of the register G3 is used as the first bit of the key 231.

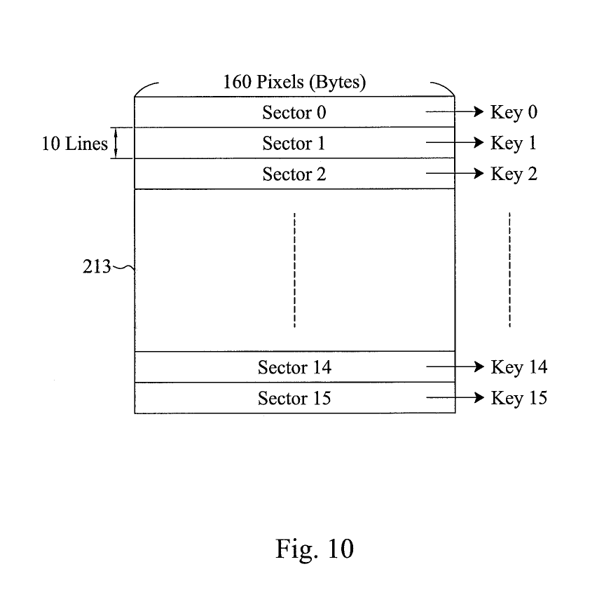

The fingerprint image data 213 may be divided into a plurality of sectors and then different keys 231 are used for encryption to on one hand reduce the risk that the whole image is decrypted in an illegal manner, and to on the other hand address the limitation caused by the periodic nature of the linear feedback shift register. FIG. 10 shows the fingerprint image data 213 having 160×160 pixels (bytes), wherein each 10 continuous lines of pixel data form a sector, and each sector uses a scrambling value Sn generated from a different key 231 for encryption. For example, Sector 0 is associated with the key 0, and Sector 1 is associated with the key 1, and so on.

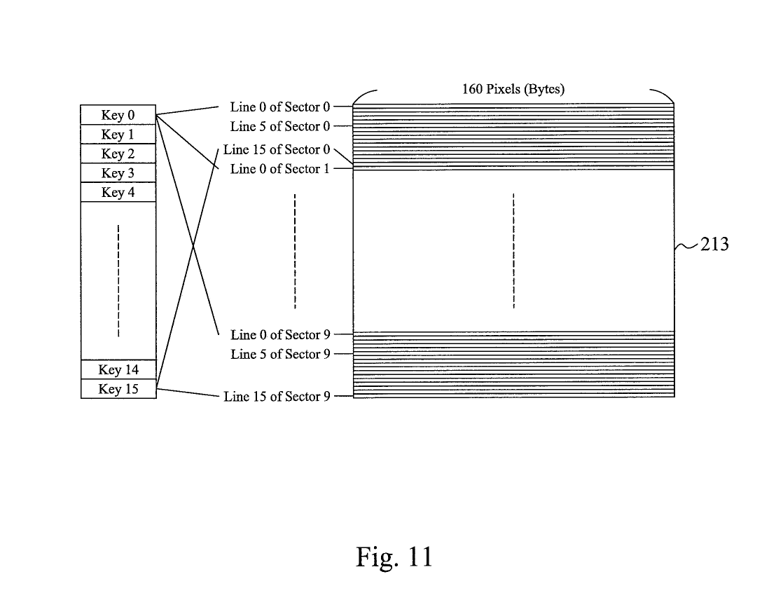

FIG. 11 shows another division arrangement of the fingerprint image data 213. Similar to that shown in FIG. 10, the fingerprint image data 213 comprises 160×160 pixels (bytes), and it is herein divided into 16 sectors each using a different key 231 for encryption, but the lines of pixel data in the sector are not continuous. For example, Line 0 of Sector 0 is the pixel data of Line 0 in the fingerprint image data 213, and Line 1 of Sector 0 is the pixel data of Line 16 in the fingerprint image data 213, while Line 2 of Sector 0 is the pixel data of Line 32 in the fingerprint image data 213, and so on. In other words, the lines of the pixel data in the same sector are separated equally in the fingerprint image data 213.

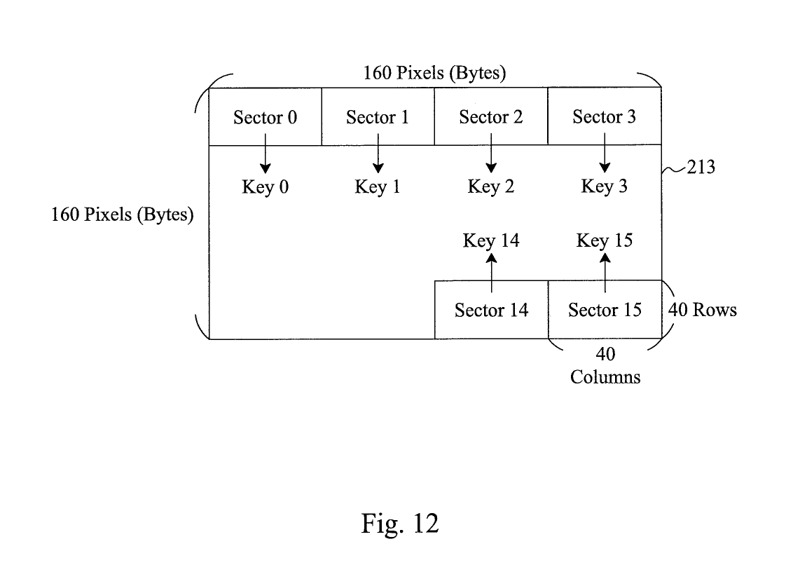

FIG. 12 shows yet another division arrangement of the fingerprint image data 213. In this embodiment, the 160×160 pixels (bytes) of the fingerprint image data 213 is divided into 16 sectors 0-15 sized 40×40. The 16 sectors 0-15 each uses a scrambling value Sn generated from a different key 0-15. For example, Sector 0 is associated with the key 0, and Sector 1 is associated with the key 1, and so on.

What is claimed is:

1. A fingerprint-sensing integrated circuit, comprising:
a fingerprint-sensing device sensing a fingerprint to generate a fingerprint image data;
a linear feedback shift register generating a plurality of scrambling values according to a key; and
a scrambling encryption circuit connected to the linear feedback shift register and the fingerprint-sensing device, performing scrambling encryption on the fingerprint image data by using the plurality of scrambling values so as to generate secured fingerprint image data;
wherein the fingerprint image data and the secured fingerprint image data are equivalent in terms of data volume, and the fingerprint-sensing integrated circuit sends the secured fingerprint image data to a remote system host through a Tx/Rx interface for fingerprint verification.

2. The fingerprint-sensing integrated circuit of claim 1, wherein the fingerprint image data comprises a plurality of first pixel data, the secured fingerprint image data comprises a plurality of second pixel data, and the plurality of scrambling values are used for scrambling encryption of the plurality of first pixel data, respectively, to generate the plurality of second pixel data.

3. The fingerprint-sensing integrated circuit of claim 1, wherein the scrambling encryption circuit comprises an XOR gate.

4. The fingerprint-sensing integrated circuit of claim 1, wherein the key is provided by the system host, or by the fingerprint-sensing integrated circuit, or is generated as an agreement between the system host and the fingerprint-sensing integrated circuit.

5. The fingerprint-sensing integrated circuit of claim 1, further comprising a key generator generating the key.

6. The fingerprint-sensing integrated circuit of claim 5, wherein the key generator comprises another linear feedback shift register generating the key.

7. The fingerprint-sensing integrated circuit of claim 5, wherein the key generator generates the key by selecting one of a plurality of predetermined seeds according to a bit sequence, and shifting the selected seed for a number of times that is determined according to the bit sequence.

8. The fingerprint-sensing integrated circuit of claim 7, wherein the bit sequence is provided by the fingerprint-sensing integrated circuit, or by the system host, or is generated as an agreement between the system host and the fingerprint-sensing integrated circuit.

9. The fingerprint-sensing integrated circuit of claim 5, wherein the key is made of a plurality of bits, and a part of the plurality of bits are of fixed values that are predetermined.

10. The fingerprint-sensing integrated circuit of claim 5, wherein the key generator comprises a plurality of registers, in which bit values stored in at least two said registers are processed by a logic operation and then used as one of the bits of the key.

11. The fingerprint-sensing integrated circuit of claim 5, wherein the key generator comprises a register, and a bit value stored in the register is used as one of bits of the key.

12. The fingerprint-sensing integrated circuit of claim 1, wherein the fingerprint image data is divided into a plurality of sectors, and the plurality of sectors perform scrambling encryption according to the plurality of scrambling values generated by the different keys, respectively, so as to generate the secured fingerprint image data.

13. A scrambling encryption method for a fingerprint-sensing integrated circuit connected to a system host through a Tx/Rx interface, the scrambling encryption method comprising the steps of:
A.) sensing a fingerprint to generate fingerprint image data;
B.) generating a plurality of scrambling values based on a key; and
C.) performing scrambling encryption on the fingerprint image data by using the plurality of scrambling values so as to generate secured fingerprint image data that is sent to the system host through the Tx/Rx interface for fingerprint verification;
wherein the fingerprint image data and the secured fingerprint image data are equivalent in terms of data volume.

14. The scrambling encryption method of claim 13, wherein the step C comprises performing scrambling encryption on a plurality of first pixel data of the fingerprint image data using the plurality of scrambling values, respectively, so as to generate a plurality of second pixel data that form the secured fingerprint image data.

15. The scrambling encryption method of claim 13, wherein the step C comprises performing scrambling encryption using an XOR operation.

16. The scrambling encryption method of claim 13, further comprising having the key provided by the system host, or by the fingerprint-sensing integrated circuit, or generated as an agreement between the system host and the fingerprint-sensing integrated circuit.

17. The scrambling encryption method of claim 13, further comprising selecting one of a plurality of predetermined seeds according to a bit sequence, and shifting the selected seed for a number of times determined according to the bit sequence, so as to generate the key, wherein the bit sequence is provided by the fingerprint-sensing integrated circuit, or by the system host, or is generated as an agreement between the system host and the fingerprint-sensing integrated circuit.

18. The scrambling encryption method of claim 17, further comprising having the key provided by a key generator that comprises linear feedback shift registers.

19. The scrambling encryption method of claim 18, further comprising setting a part of bits of the key into predetermined, fixed values.

20. The scrambling encryption method of claim 18, further comprising performing a logic operation on bit values stored in at least two said registers in the key generator and using a result of the operation as one of bits of the key.

21. The scrambling encryption method of claim 18, further comprising using bit values stored in one said register of the key generator as one of bits of the key.

22. The scrambling encryption method of claim 13, wherein the step C comprises dividing the fingerprint image data into a plurality of sectors and performing scrambling encryption using the plurality of scrambling values generated from different said keys.

23. A fingerprint-sensing integrated circuit, comprising:
a fingerprint-sensing device sensing a fingerprint to generate a fingerprint image data, the first fingerprint image data being divided into a plurality of sectors, each said sector containing a plurality of first pixel data;
a linear feedback shift register generating a plurality of scrambling values according to a key corresponding to a sector to be encrypted presently; and
a scrambling encryption circuit connected to the linear feedback shift register and the fingerprint-sensing device, using the plurality of scrambling values to perform scrambling encryption on a plurality of pixel data of the sector to be encrypted presently so as to generate a plurality of secured pixel data,
wherein all the secured pixel data generated by scrambling encryption of all the plurality of sectors form secured fingerprint image data, in which the fingerprint image data and the secured fingerprint image data are equivalent in terms of data volume, and the fingerprint-sensing integrated circuit sends the secured fingerprint image data to a remote system host through a Tx/Rx interface for fingerprint verification.

24. The fingerprint-sensing integrated circuit of claim 23, wherein the scrambling encryption circuit comprises an XOR gate.

25. The fingerprint-sensing integrated circuit of claim 23, wherein the key is provided by the system host, or by the fingerprint-sensing integrated circuit, or is generated as an agreement between the system host and the fingerprint-sensing integrated circuit.

26. The fingerprint-sensing integrated circuit of claim 23, further comprising a key generator generating the key.

27. The fingerprint-sensing integrated circuit of claim 26, wherein the key generator comprises another linear feedback shift register generating the key.

28. The fingerprint-sensing integrated circuit of claim 26, wherein the key generator selects one of a plurality of predetermined seeds according to a bit sequence, and shifting the selected seed for a number of times determined according to the bit sequence so as to generate the key.

29. The fingerprint-sensing integrated circuit of claim 28, wherein the bit sequence is provided by the fingerprint-sensing integrated circuit, or by the system host, or is generated as an agreement between the system host and the fingerprint-sensing integrated circuit.

30. The fingerprint-sensing integrated circuit of claim 26, wherein the key is made of a plurality of bits, and a part of the plurality of bits are of fixed values that are predetermined.

31. The fingerprint-sensing integrated circuit of claim 26, wherein the key generator comprises a plurality of registers, in which bit values stored in at least two registers are processed by a logic operation and then used as one of bits of the key.

32. The fingerprint-sensing integrated circuit of claim 26, wherein the key generator comprises a register, and a bit value stored in the register is used as one of a plurality of bits of the key.

33. A scrambling encryption method for a fingerprint-sensing integrated circuit connected to a system host through a Tx/Rx interface, the scrambling encryption method comprising the steps of:
A.) sensing a fingerprint to generate fingerprint image data;
B.) dividing the fingerprint image data into a plurality of sectors, each said sector containing a plurality of first pixel data;
C.) providing a key according to the sector to be encrypted presently;
D.) generating a plurality of scrambling values based on the key; and
E.) performing scrambling encryption on the plurality of pixel data of the sector to be encrypted by using the plurality of scrambling values so as to generate a plurality of secured pixel data,
wherein all the secured pixel data generated by scrambling encryption of all the plurality of sectors form secured fingerprint image data, in which the fingerprint image data and the secured fingerprint image data are equivalent in terms of data volume, and the secured fingerprint image data is sent to the remote system host through the Tx/Rx interface for fingerprint verification.

34. The scrambling encryption method of claim 33, wherein the step E comprises using an XOR operation to achieve scrambling encryption.

35. The scrambling encryption method of claim 33, further comprising having the key provided by the system host, or by the fingerprint-sensing integrated circuit, or generated as an agreement between the system host and the fingerprint-sensing integrated circuit.

36. The scrambling encryption method of claim 33, further comprising selecting one of a plurality of predetermined seeds according to a bit sequence, and shifting the selected seeds for a number of times determined according to the bit sequence so as to generate the key, wherein the bit sequence is provided by the fingerprint-sensing integrated circuit, or by the system host, or is generated as an agreement between the system host and the fingerprint-sensing integrated circuit.

37. The scrambling encryption method of claim 36, further comprising having the key provided by a key generator that comprises linear feedback shift registers.

38. The scrambling encryption method of claim 37, further comprising setting a part of bits of the key into predetermined, fixed values.

39. The scrambling encryption method of claim 37, further comprising performing a logic operation on bit values stored in at least two said registers in the key generator and using a result of the operation as one of bits of the key.

40. The scrambling encryption method of claim 37, further comprising using bit values stored in one said register of the key generator as one of bits of the key.
